(19) United States
(12) Patent Application Publication
(10) Pub. No.: US 2008/0244396 A1
(43) Pub. Date: Oct. 2, 2008

(54) Method for Analyzing a Process of a Communication Taking Place Between at Least Two Instances

(75) Inventors: Martin McDonald, Berlin (DE); Martin Polak, Berlin (DE)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX INTERNATIONAL SALES GMBH, Rheinfall (CH)

(21) Appl. No.: 11/958,329

(22) Filed: Dec. 17, 2007

(30) Foreign Application Priority Data
Dec. 15, 2006 (EP) 06026078.3
Dec. 15, 2006 (EP) 06026079.1

(51) Int. Cl. G06F 3/00

(52) U.S. Cl. 715/700

(57) ABSTRACT

Embodiments of the present invention relate to a method for analyzing a process of a communication taking place between at least two instances, wherein the communication process comprises a sequence of several calls, which in turn comprise at least one message, wherein the communication process is represented on a display unit by symbols, and wherein a first plurality of messages forms a first procedure and a second plurality of messages forms a second procedure, and the first plurality of messages is represented by a first symbol and the second plurality of messages is represented by a second symbol, so that one procedure each is represented by a single symbol. Embodiments of the invention also relate to protocol testers for performing the method.

### BACKGROUND

Embodiments of the present invention relate to methods for analyzing a process of a communication taking place between at least two instances, wherein the communication process comprises a sequence of several calls, which in turn comprise at least one message, wherein the communication process is represented on a display unit by symbols, and a first plurality of messages forms a first procedure, and a second plurality of messages forms a second procedure. Further embodiments present invention relate to methods for analyzing a process of a communication taking place between at least two instances, wherein the communication process comprises a sequence of several calls, which in turn comprise at least one message, wherein the at least one message is represented on the display unit by a symbol and to each symbol there is assigned, according to a default setting, an optical feature, and wherein a first procedure comprises at least one first message and a second procedure comprises at least one second message and the occurrence of the first message is correlated with a successful or unsuccessful completion of the first procedure and the occurrence of the second message is correlated with a successful or unsuccessful completion of the second procedure. It also relates to a corresponding protocol tester for analyzing a process of a communication taking place between at least two instances.

It is known that protocol testers are used for monitoring communication processes, for example, in mobile radio networks. During this, there are generated large quantities of data, which have to be analyzed. It is known that in order to enable a user to analyze the data recorded, there are displayed on a display unit, for example a computer screen, data relating to a communication process, there being provided, on the display unit, for each call of a communication process, a line in which information on said call is displayed. A call comprises individual protocol messages, hereinafter referred to as messages, and is defined, in the case of the transmission of speech, as a sequence of messages from the connection set-up through to the connection release. In the case of the transmission of data, a series of messages, from the context activation through to the context deactivation, can be represented as a call. Moreover, one or a plurality of context activations are prepared by an attach procedure. Said procedure is represented either as a call in its own right or, in connection with context activation and deactivation, as a call. The same applies, mutatis mutandis, to a detach procedure, which serves to end a data connection. In addition, there are messages or procedures, which are not assigned directly neither to speech calls nor to data calls and are represented as calls in their own right, e.g. paging messages. In order to be able to show a message sequence within a line, each message is represented by a symbol.

FIG. 1 (Prior Art) shows as an example of this kind of representation a detailed view of a window of a graphical user interface of a protocol tester known as an Agilent Signaling Analyzer. This picture has been taken from the brochure “Agilent Signaling Analyzer—Technical Overview” from Agilent Technologies. In the area of the window with the heading “Phase Graphics” the individual messages of a call are represented as small boxes, which, in the original, exhibit different colors, which can be seen in FIG. 1 as shades of grey. Some of the boxes also exhibit an icon.

In the following there will be explained, by way of an example, the relation between the messages and the symbols representing the messages. FIG. 2a (Prior Art) shows a communication process, which comprises a call 10, between a first instance 1 and a second instance 2, wherein one arrow corresponds to one message. First, the instance 1 sends an “Attach Request” 11 to the instance 2. The latter asks the instance 1 by way of an “Identification Request” message 12 to identify itself. Instance 1 responds thereto with an “Identification Response” message 13. Next, the instance 2 sends an “Authentification and Ciphering Request” message 14 to the instance 1. As a reply, the instance 1 sends an “Authentification and Ciphering Response” 15, to prove its authenticity. Next, the instance 2 sends an “Attach Accept” message 16 in response to the “Attach Request” message 11. Finally, the instance 1 confirms receipt of the “Attach Accept” message 16 with an “Attach Complete” message 17.

From FIG. 2b(Prior Art) there can be seen how this message sequence according to the prior art is represented by symbols. Each of the messages 11 to 17 is represented by a symbol 31 to 37 in the form of a small box, each message being assigned another color, appearing in FIG. 2b as shades of grey. In this way, a call 10 can be represented in a line, so that in a window there can be accommodated a sequence of many calls as a so-called call flow. However, given the large quantities of data, it continues to be difficult for a user to obtain a quick overview of the monitored communication process.

### SUMMARY

Embodiments of the present invention is based on the realization that the information made available to users can be reduced to what is essential, thus facilitating for them the analysis of a communication process, if the representation of a call is at procedure level. To this end, instead of individual messages, there are represented entire procedures by a symbol each. Further embodiments of the present invention are based on the realization that the analysis of a communication process can be made easier for a user, if the symbols, which represent the individual messages, provide information on whether a procedure to which the messages belong has been completed successfully. According to a standard underlying the communication process, for example TS 24.008 of 3 GPP, one or a plurality of associated messages form a procedure. As can also be seen from FIG. 2a, messages forming a procedure within a call do not necessarily succeed one another directly, but several procedures may be intertwined. This makes it more difficult for a user to obtain an overview of a communication process. By combining the individual messages to form procedures in the representation of a call, the clarity and readability of a call flow are significantly improved, which makes the analysis of the data easier and faster. A call can consist of many messages. This makes it more difficult for the user to quickly capture the process of a call. As the symbols, which represent messages, which are correlated with a successful or unsuccessful process of the associated procedure, exhibit an optical feature, which indicates the condition or the status of the respective procedure, the user can detect at a first glance whether a procedure was completed successfully or whether errors have occurred. This allows the user to concentrate on failed calls, which are usually of most interest in the monitoring of communication processes.

In certain embodiments, each symbol is assigned an optical feature, which is allocated to the procedure represented by the symbol. This makes it easy to identify the procedures shown. Each symbol is assigned an optical feature, which is allocated to the status of the procedure represented by the symbol. This makes it evident at a first glance whether a procedure was completed successfully or whether errors have occurred. The representation of procedures by symbols providing information about the status of the relevant procedure considerably facilitates the analysis of a communication process because the user no longer has to check for each individual procedure whether all associated messages have been properly received. The fact that the status of a procedure can be seen from the symbol representing the procedure allows the user to concentrate on failed calls, which are usually of most interest in the monitoring of communication processes. The optical feature can be a color, a shade of grey, an icon or a mnemonic, i.e. a letter abbreviation.

According to another embodiment of the invention there are assigned to the symbol of each procedure a mnemonic to indicate the procedure and a background color, or a shade of grey, to indicate the status of the procedure. Alternatively, instead of the mnemonic, an icon may be assigned to the symbol to indicate the procedure.

According to an alternative embodiment there are assigned to the symbol of each procedure a field with a color, or a shade of grey, to indicate the procedure and an icon arranged in said field or a mnemonic to indicate the status of the procedure. Said field may be a square or a rectangle, but it can also have another shape.

For the representation of a sequence of several calls, the procedures belonging to a call are represented in a line. In a further embodiment, for each call in the line containing the procedures belonging to the call, there is shown additional information relating to the call.

In a further embodiment, upon a user activation relating to the symbol of a procedure on the display unit, a window opens automatically, in which there are given the individual messages of the call to which the procedure belongs. The user activation can be a moving of a cursor across the symbol of the procedure on the display unit. Alternatively it can also be the moving of a mouse pointer to the symbol in connection with a simple click or a double click. This functional feature allows the user a more detailed analysis of a failed procedure.

In order to further reduce the data quantity offered to the user, the symbols representing the procedures provide a definition of at least one filter rule. Since the symbols provide information on both the type and the status of a procedure, a filter can be placed on a status of a procedure. This way the defining of filter rules is simplified considerably in comparison to the prior art.

The first and the second procedure preferably each comprise at least one further message, and there is assigned, in the default setting, to the symbols of the messages of the first procedure in addition a third optical feature, and to the symbols of the messages of the second procedure in addition a forth optical feature. This causes the representation of the communication process to be even more clearly laid out, because it is evident right away which messages belong to a procedure. As can also be seen from FIG. 2a, messages forming a procedure within a call do not necessarily succeed one another directly, but several procedures may be intertwined. If therefore all symbols exhibit an optical feature, which provides information about the belonging of the message represented by the symbol to a procedure, then it is much easier for the user to check whether a call has gone properly, or, in case of a failed call, to find out where an error has occurred. The optical feature can be a color, a shade of grey, an icon or a mnemonic, i.e. a letter abbreviation.

According to another embodiment of the invention there are assigned to the symbols of all messages belonging to a procedure a colored field in the same color. The common color makes it especially easy to recognize the belonging of messages to a procedure. Alternatively, instead of colors, shades of grey may also be used. The field is preferably a square or a rectangle, but it can also have another shape. It is especially preferred if the symbol of the message correlating with a successful or unsuccessful completion of a procedure is also assigned an icon, arranged in the colored field, or a mnemonic to indicate the successful or unsuccessful completion of a procedure. Alternatively, there may be assigned to the symbol of the message correlating with a successful or unsuccessful completion of a procedure a darker color field than to the other messages of this procedure if the message has been completed successfully, and a lighter color field than to the other messages of this procedure if the message has been completed unsuccessfully.

Where applicable, the preferred embodiments and advantages described in connection with the method according to the present invention also apply to the protocol tester according to the present invention. In the following, one embodiment of the invention is described in more detail with reference to the figures attached:

### BRIEF DESCRIPTION OF THE DRAWINGS

FIG. 1(Prior Art) illustrates a partial view of a graphical user interface of a method for analyzing a communication process;

FIG. 2a(Prior Art) illustrates a sequence of messages which are exchanged between two instances and which form a call;

FIG. 2b (Prior Art) is a representation of the call in FIG. 2a by symbols;

FIG. 3a (Prior Art) shows the same sequence of messages as in FIG. 2a forming a call;

FIG. 3b is a representation, according to an embodiment of the present invention, of the call in FIG. 3a by symbols;

FIG. 4a (Prior Art) shows a sequence of messages, which represent a failed call, corresponding to the sequence in FIG. 3a; and

FIG. 4b illustrates a representation, according to an embodiment of the present invention, of the call in FIG. 4a by symbols.

FIG. 5a (Prior Art) shows the same sequence of messages as in FIG. 2a forming a call;

FIG. 5b is a representation, according to an embodiment of the present invention, of the call in FIG. 5a by symbols;

FIG. 6a (Prior Art) shows a sequence of messages, which represent a failed call, corresponding to the sequence in FIG. 5a; and

FIG. 6b is a representation, according to an embodiment of the present invention, of the call in FIG. 6a by symbols.

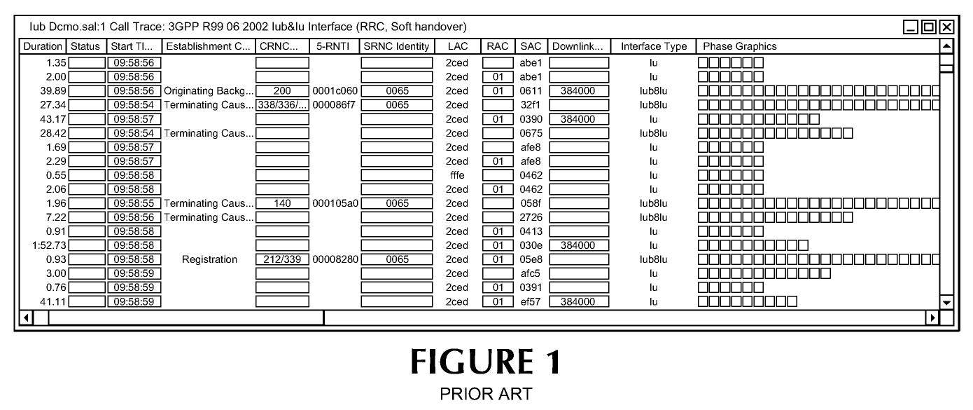

### DETAILED DESCRIPTION

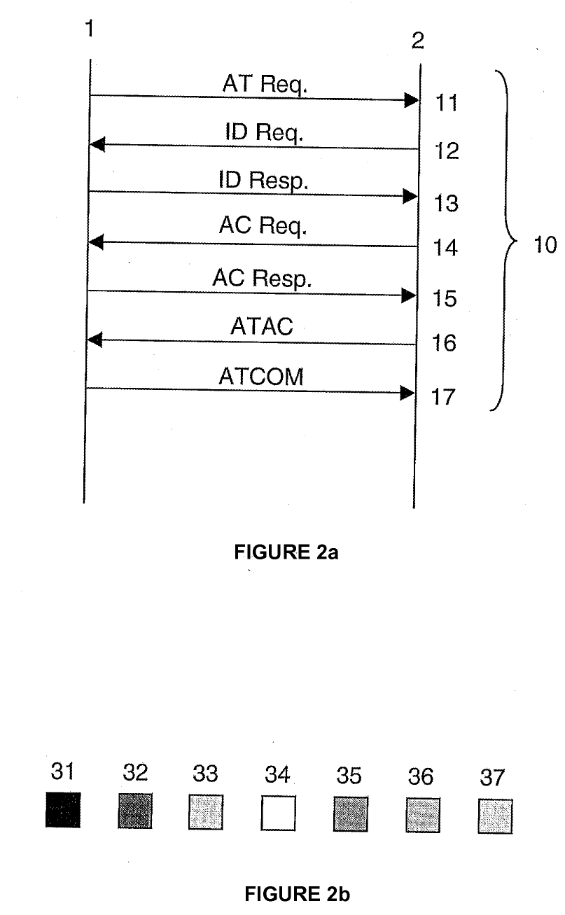

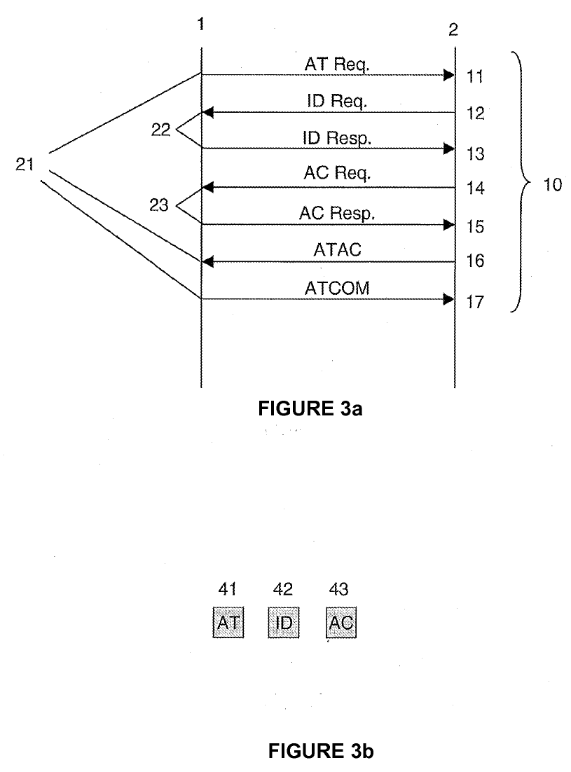

FIG. 3a shows once again the call 10 represented in FIG. 2a with the message sequence 11 to 17. Elements of the prior art and the invention, which correspond to each other, are shown in the drawings with the same reference numerals. From FIG. 3b it is evident how the messages 11 to 17 of the call 10 shown in FIG. 3a are represented according to an embodiment of the invention. As in the prior art there is envisaged for each call a line on the display unit. In this line there may be displayed further information relating to the call, such as a call identification number. However, not every message is represented by a symbol of its own. Instead, messages belonging to one procedure are combined and represented by one single symbol. So the messages “Attach Request” 11, “Attach Accept” 16 and “Attach Complete” 17 shown in FIG. 3a form a procedure 21, which is represented by the symbol 41. The messages “Identity Request” 12 and “Identity Response” 13 form a procedure 22 to which there corresponds symbol 42 on the display unit. The messages “Authentification and Ciphering Request” 14 and “Authentification and Ciphering Response” 15 finally form a procedure 23, which is represented by the symbol 43, the symbols for the procedures being represented in the sequence in which in each case first messages of the procedures occur.

According to an embodiment of the invention shown in FIG. 3b, the procedures are identified by letter abbreviations. However, is also possible to assign to the symbols representing the individual procedures, as an optical feature for designating the procedure, an icon, a color or a shade of grey. In addition, there can be seen from FIG. 3b the condition or the status of the respective procedure. The shade of grey of the symbols 41, 42 and 43, which are used in FIG. 3b, designate the successful completion of the procedures 21, 22 and 23. According to the embodiment shown in FIG. 3b, the letter abbreviation or the mnemonic is in a field, for example a small box, or a circle, having the corresponding shade of grey. Alternatively, the mnemonic itself can also be shown in the corresponding shade of grey.

The status of the procedures can be represented even more clearly with a color display. Successfully completed procedures, for example, can be represented by a green symbol, while rejected procedures can be represented by a red symbol. Procedures started but not completed or procedures with a time-out, i.e. procedures that could not be not completed successfully because not all messages arrived in the specified time, can be marked by a yellow symbol. Procedures during which another error occurred can be marked with another noticeable color such as magenta. This way the readability of call flows is substantially facilitated because the information shown is, on the one hand, reduced to what is essential while, on the other hand, errors that occur are highlighted.

In an alternative embodiment, in which colors, or shades of grey, are used in order to mark the procedure, the status of the procedure can be displayed by icons or mnemonics.

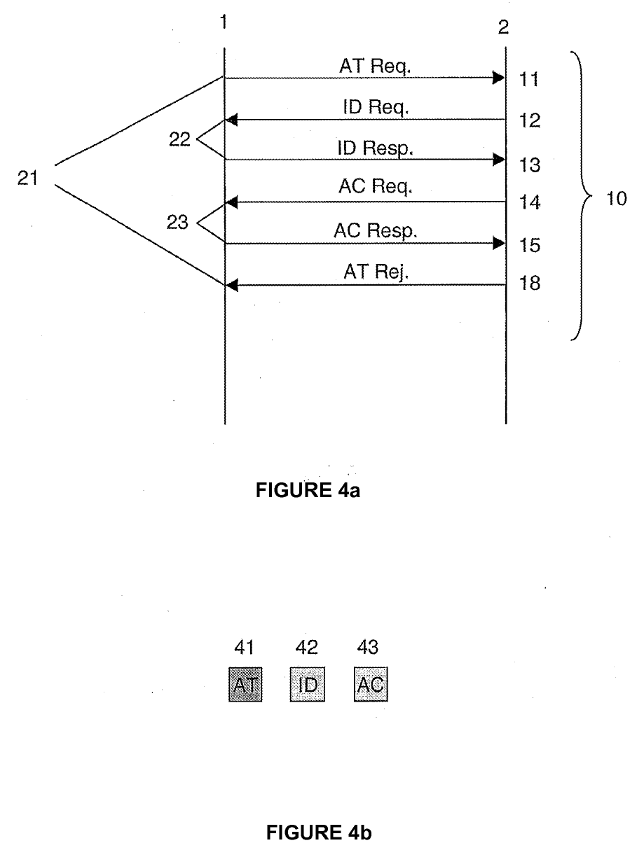

FIG. 4a shows in a call 10, in which the instance 2 sends to the instance 1, as a last message, an “Attach Reject” 18 instead of an “Attach Accept” 16, thus rejecting the “Attach” 21 procedure. From FIG. 4b there can be seen the representation of the call 10 for this case. The fact that the “Attach” 21 procedure was not completed successfully is indicated by a symbol 41 with a white background. This way the user can see right away during which procedure an error has occurred. For a more accurate analysis of the error that has occurred, this embodiment exhibits another functional feature. If the user moves on the display unit a mouse pointer to a symbol representing a procedure, there opens, by means of a double click on the symbol, another window in which there are shown the individual messages of the call to which the procedure belongs. This representation can occur in a form as is shown in FIG. 4a.

According to another embodiment of the invention, it is also possible to further reduce the data quantity represented on the display unit through the use of filters. Since a distinction according to the status of the procedure is made for the representation, it is possible to place filters on the statuses of the procedures, so that e.g. only procedures that have been rejected are displayed. This allows an easy configuration of filters.

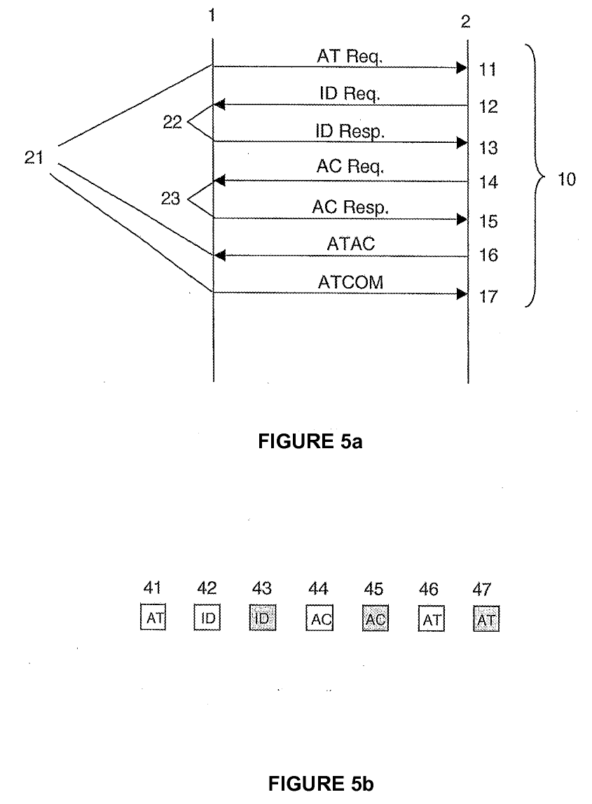

FIG. 5a shows once again the call 10 represented in FIG. 2a with the message sequence 1 to 17. Elements of the prior art and the invention, which correspond to each other, are shown in the drawings with the same reference numerals. From FIG. 5b it is evident how the messages 11 to 17 of the call 10 shown in FIG. 3a are represented according to a preferred embodiment of the invention. As in the prior art there is envisaged for each call a line on the display unit. In said line there may be displayed further information relating to the call, such as a call identification number. In contrast to the prior art, however, there is assigned, in accordance with a default setting, a common optical feature to the symbols representing the messages correlating with a successful or unsuccessful completion of a procedure, the optical feature indicating the condition or status of the procedure. At the same time, the symbols of all messages belonging to a procedure are assigned a common optical feature, which indicates which procedure it is. Especially the messages “Attach Request” 11, “Attach Accept” 16 and “Attach Complete” 17, which are shown in FIG. 3a, form a procedure 21. The symbols 41, 46 and 47 representing said messages are identified in FIG. 3b by the letter abbreviation or the mnemonic “AT”. Moreover, the symbol 47, which represents the “Attach Complete” 17 message associated with a successful completion of the procedure, exhibits a shade of grey indicating the successful completion of the “Attach” procedure. Likewise, the messages “Identity Request” 12 and “Identity Response” 13 shown in FIG. 3a form a procedure 22, while the messages “Authentification and Ciphering Request” 14 and “Authentification and Ciphering Response” 15 form a procedure 23. The symbols 42 and 43 representing the messages belonging to the procedure 22 are provided with the mnemonic “ID” in accordance with FIG. 3b to indicate the procedure. In the case of the symbols 44 and 45 representing the messages belonging to the procedure 23 the procedure is indicated by the mnemonic “AC”. In addition, the shade of grey forming the background to the symbols 43 and 45, on which the respective mnemonic is situated, indicates that the procedures 22 and 23 were completed successfully. The background to the symbols 41, 42, 44 and 46 representing the messages, which are not connected with a successful or unsuccessful completion of a procedure, has, in contrast, been left white.

The status of the procedures can be represented even more clearly with a colored display instead of shades of grey. Successfully completed procedures, for example, can be represented by a green symbol, while rejected procedures can be represented by a red symbol. Procedures during which another error occurred can be marked with another noticeable color such as magenta.

The belonging to a procedure is expressed in FIG. 5b by a letter abbreviation. Alternatively, however, icons may also be used therefor. According to the embodiment shown in FIG. 3b, the letter abbreviation or the mnemonic is in a field, for example a small box or a circle having the corresponding shade of grey. Alternatively, the mnemonic itself can also be shown in the corresponding shade of grey.

In an alternative embodiment, in which colors or shades of grey are used to mark the procedure, the status of the procedure may be displayed by icons or mnemonics. However, it is also possible to do entirely without icons or mnemonics and to have, instead, the belonging to a procedure expressed by colors, wherein the symbol representing a message correlating with a successful or unsuccessful completion of a procedure is lighter or darker, depending on the status of the procedure, than the remaining symbols representing the messages belonging to the procedure.

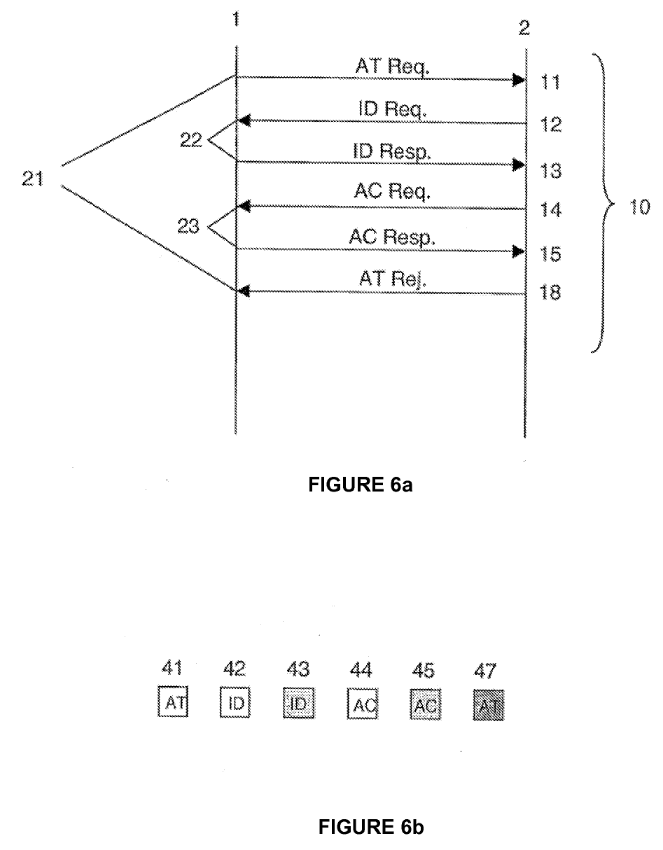

FIG. 6a shows in a call, in which the instance 2 sends to the instance 1, as a last message, an “Attach Reject” 18 instead of an “Attach Accept” 16, thus rejecting the “Attach” procedure 21. From FIG. 6b there can be seen the representation of the call 10 for this case. For the symbols 41 to 45 the representation corresponds to that of FIG. 5b. The last symbol 47 representing the “Attach Reject” message 18 shows by way of a shade of grey differing from the shade of grey used for the symbols 43 and 45 that the “Attach” procedure 21 was not completed successfully. This way the user can see right away during which procedure an error has occurred.

An alternative embodiment of the invention also exhibits another functional feature. If the user moves on the display unit a mouse pointer to a symbol representing a message, there opens, by means of a double click on the symbol, another window in which there are shown the individual messages of the call to which the procedure belongs. This representation can occur in a form as is shown in FIGS. 2a, 3a, 4a, 5a and 6a. In addition the selected message may be highlighted by bold print.

A further embodiment of a protocol tester according to the invention exhibits a display unit, on which there is representable according to the method according to the present invention, in a line by means of symbols, in each case one call of a sequence of calls forming a communication process to be analyzed.

What is claimed is:

1. A method for analyzing a process of a communication taking place between at least two instances, wherein the communication process comprises a sequence of several calls, which in turn comprise at least one message and wherein a first plurality of messages forms a first procedure and a second plurality of messages forms a second procedure comprising:
representing the first plurality of messages by a first symbol and the second plurality of messages is represented by a second symbol so that one procedure is in each case represented by a single symbol; and
displaying the communication process on a display unit using the first symbol and the second symbol.

2. The method according to claim 1, wherein each symbol is assigned an optical feature that is allocated to the procedure represented by the symbol.

3. The method according to claim 2, wherein the optical feature corresponds to the status of the procedure represented by the symbol.

4. The method according to claim 3, wherein the optical feature is a color, a shade of grey, an icon or a mnemonic.

5. The method according to claim 4, wherein for each symbol of each procedure an icon or a mnemonic to indicate the procedure has a background color or a shade of grey to indicate the status of the procedure.

6. The method according to claim 4, wherein each symbol of each procedure comprises a field having a color or a shade of grey to indicate the procedure and an icon, or a mnemonic, arranged in the field to indicate the status of the procedure.

7. The method according to claim 1, wherein each procedure belonging to a call are represented in a line.

8. The method according to claim 7, further comprising displaying additional information relating to each call in the line containing the procedures belonging to the call.

9. The method according to claim 1, further comprising opening an additional window to display individual messages of the call to which the procedure belongs.

10. The method according to claim 8, further comprising opening an additional window to display individual messages of the call to which the procedure belongs.

11. The method of claim 1, further comprising defining at least one filter based upon a symbol representing a procedure.

12. A method for analyzing a process of a communication taking place between at least two instances, wherein the communication process comprises a sequence of several calls, which in turn comprise at least one message, and wherein a first procedure comprises at least one first message and a second procedure comprises at least one second message and the occurrence of the first message is correlated with a successful or unsuccessful completion of the first procedure, and the occurrence of the second message is correlated with a successful or unsuccessful completion of the second procedure comprising:
representing at least one message on a display unit by a symbol, and to each symbol assigning an optical feature, according to a default setting;
displaying according to the default setting a first optical feature assigned to the symbols of the first and of the second message for a successful completion of the respective associated procedure, and a second optical feature assigned for an unsuccessful completion of the respective associated procedure.

13. The method according to claim 12, wherein the first and the second procedure each comprise at least one further message and in the default setting there are assigned to the symbols of the messages of the first procedure, in addition, a third optical feature and to the symbols of the messages of the second procedure, in addition, a forth optical feature.

14. The method according to claim 13, wherein the optical features are a color, a shade of grey, an icon or a mnemonic.

15. The method according to claim 14, wherein there are assigned to the symbols of all messages belonging to a procedure a colored field in the same color.

16. The method according to claim 15, wherein there is assigned to the symbol of the message correlating with a successful or unsuccessful completion of a procedure in addition an icon, arranged in a colored field, or a mnemonic to display the successful or unsuccessful completion of the procedure, respectively.

17. The method according to claim 14, wherein there is assigned to the symbols of all messages belonging to a procedure the same icon or the same mnemonic.

18. The method according to claim 17, wherein there is assigned to the symbol of the message correlating with a successful or unsuccessful completion of a procedure a background color to display the successful or unsuccessful completion of the procedure.

19. The method according to claim 12, wherein the messages belonging to a call are represented in a line.

20. The method according to claim 19, wherein there is displayed for each call in the line containing the messages belonging to the call additional information relating to the call.

21. The method according to claim 20, further comprising opening an additional window to display individual messages of the call to which the procedure belongs and highlighting said message in the window.
